(19) United States
(12) Patent Application Publication
(10) Pub. No.: US 2023/0135481 A1
(43) Pub. Date: May 4, 2023

(54) CONNECTION DEVICE

(71) Applicant: PLS CO., LTD, Sacheon-si, Gyeongsangnam-do (KR)

(72) Inventors: Yun Chul LEE, Jinju-si, Gyeongsangnam-do (KR); Chang Min LEE, Jinju-si, Gyeongsangnam-do (KR); Ju Hwa KIM, Jinju-si, Gyeongsangnam-do (KR)

(73) Assignee: PLS CO., LTD, Sacheon-si, Gyeongsangnam-do (KR)

(21) Appl. No.: 17/912,044

(22) PCT Filed: Apr. 7, 2021
(86) PCT No.: PCT/KR2021/004358

§ 371 Date: Sep. 16, 2022

(30) Foreign Application Priority Data
Apr. 10, 2020 (KR) 10-2020-0043705

(51) Int. Cl. F16L 21/00; F16L 21/03

(52) U.S. Cl. CPC F16L 21/007; F16L 21/03; F16L 21/08

(57) ABSTRACT

Disclosed is an invention relating to a connection device which includes: a housing unit having a pipe inserted therein; a fixing unit that is inserted between the pipe and the housing unit by rotation to fix the pipe; and a sealing unit provided between the housing unit and the pipe to seal between the housing unit and the pipe.

### TECHNICAL FIELD

The present disclosure relates to a connection device and, more particularly, to a connection device capable of easily connecting a pipe or the like.

### BACKGROUND ART

In general, a connection device, for connecting pipes or the like, connects a plurality of pipes by applying a coupling method such as welding. Accordingly, the connection device is used to extend a length of a pipe or to change a flow direction of a fluid whose movement is guided through the pipe.

In conventional connection devices, a welding method is mainly applied, so that expensive welding equipment may be required and the quality of the connection device may vary depending on an operator.

In addition, when a fusion method is used in a conventional connection device for connecting pipes, the conventional connection device requires expensive equipment and an expert for application of compression, wedge, or the like. Therefore, there is a need to improve the conventional connection device.

Background art of the present disclosure is disclosed in Korean Patent Publication No. 10-1863582 (registered on May 28, 2018, entitled “Pipe connection device”).

### DISCLOSURE

### Technical Problem

In view of improving the above problems, the present disclosure provides a connection device having a simple configuration which makes it easy to connect pipes, and capable of stably connecting pipes of various materials.

### Technical Solution

A connection device according to the present disclosure includes: a housing part into which a pipe is inserted; a fixing part which is inserted between the pipe and the housing part in response to rotation to fix the pipe; and a sealing part provided between the housing part and the pipe to seal between the housing part and the pipe.

In the present disclosure, the housing part includes: a housing body portion into which the pipe is inserted; and a housing guide portion which is connected to the housing body portion and has an inner diameter gradually decreased as going toward the housing body portion.

In the present disclosure, the housing body portion includes: a housing body member in which a housing body hole portion into which the pipe is inserted is formed; and a pipe insertion limiting portion protruding from the housing body hole portion to limit the degree of insertion of the pipe.

The housing guide portion in the present disclosure includes: a pipe insertion portion into which the pipe is inserted; and a pipe guide portion which connects the pipe insertion portion and the housing body portion, and is formed to have an inner diameter gradually decreased as going toward the housing body portion.

In the present disclosure, the housing part may further include a pressing protrusion protruding from an inner peripheral surface of the housing body portion or the pipe guide portion to press the pipe or the fixing part moving toward the housing body hole portion.

In the present disclosure, the fixing part includes: a rotating member rotatably coupled to the housing part and moved in a length direction of the housing part in response to rotation; and a fixing member connected to the rotating member, and provided in a shape in which an outer diameter is gradually decreased in an insertion direction of the pipe.

In the present disclosure, the rotating member is screw-coupled with the housing part.

In the present disclosure, the fixing member is deformed as being moved in contact with the housing guide portion in response to rotation of the rotation member to press the pipe.

In the present disclosure, the fixing member includes a plurality of fixing members arranged in a circumferential direction of the rotating member.

In the present disclosure, the rotating member and the fixing member are integrally formed.

### Advantageous Effects

The connection device according to the present disclosure can easily connect various pipes with a simple configuration.

In addition, the connection device according to this disclosure can accurately control and indicate the degree of insertion of the pipe inserted in the housing part by applying the pipe insertion restriction portion and a pipe insertion indication portion to the housing part.

Further, the connection device according to the present disclosure can stably fix the pipe and prevent the pipe from sagging or the like by applying the fixing part and the fixing reinforcement part.

Furthermore, the connection device according to the present disclosure can prevent the fluid guided along the pipe from leaking between the housing part and the pipe by applying the sealing part between the housing part and the pipe.

Moreover, the connection device according to the present disclosure can prevent the fixing part from being loosened by applying the fixing locking portion, the housing locking portion, the fixing reinforcement part, and the loosening prevention part to stably maintain the connection state of the pipe.

### DESCRIPTION OF DRAWINGS

FIG. 1 is a cross-sectional view illustrating a connection device according to one embodiment of the present disclosure.

FIG. 2 is a block diagram illustrating a configuration of the connection device according to one embodiment of the present disclosure.

FIG. 3 shows a cross-sectional view and a side view illustrating a housing part according to one embodiment of the present disclosure.

FIG. 4 shows a cross-sectional view and a side view illustrating a fixing part according to one embodiment of the present disclosure.

FIG. 5 is a cross-sectional view illustrating a fixing part according to another embodiment of the present disclosure.

FIG. 6 shows a cross-sectional view and a side view illustrating a fixing reinforcement part according to one embodiment of the present disclosure.

FIG. 7 is a cross-sectional view illustrating a state in which a housing part and a sealing part are coupled to each other according to one embodiment of the present disclosure.

FIG. 8 is a cross-sectional view illustrating a state in which the fixing part and the fixing reinforcement part are coupled to the housing part according to one embodiment of the present disclosure.

FIG. 9 is a cross-sectional view illustrating a state in which a pipe is inserted into the housing part in the connection device according to one embodiment of the present disclosure.

FIG. 10 is a cross-sectional view illustrating that the fixing part and the fixing reinforcement part are rotated to fix the pipe in the connection device according to one embodiment of the present disclosure.

FIG. 11 is a cross-sectional view illustrating that a loosening prevention part is coupled to the housing part and the fixing part in the connection device according to one embodiment of the present disclosure.

### MODE FOR DISCLOSURE

Hereinafter, one embodiment of a connection device according to the present disclosure will be described with reference to the accompanying drawings. In the description, thicknesses of lines or sizes of components shown in the drawings may be exaggerated for clarity and convenience of explanation.

In addition, the terms to be described below are terms defined in consideration of functions in the present disclosure, which may vary depending on intention or practices of a user or operator. Therefore, definitions of these terms should be made based on the content throughout this specification.

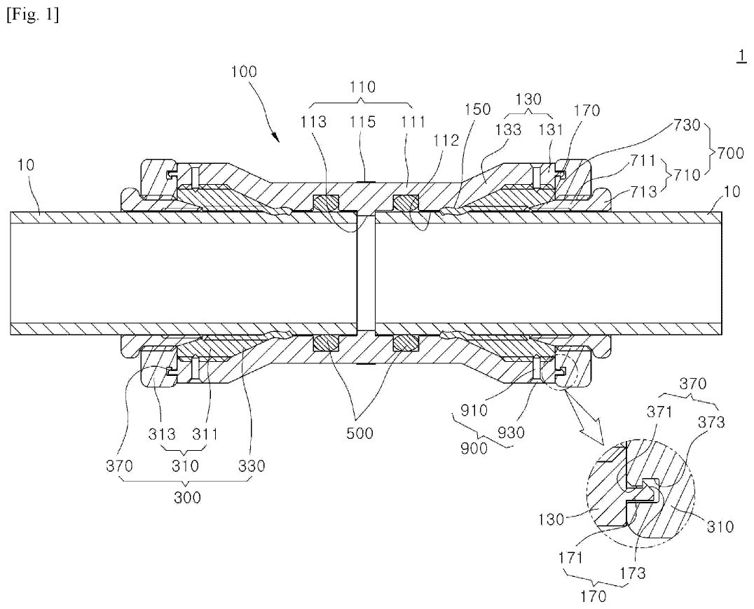

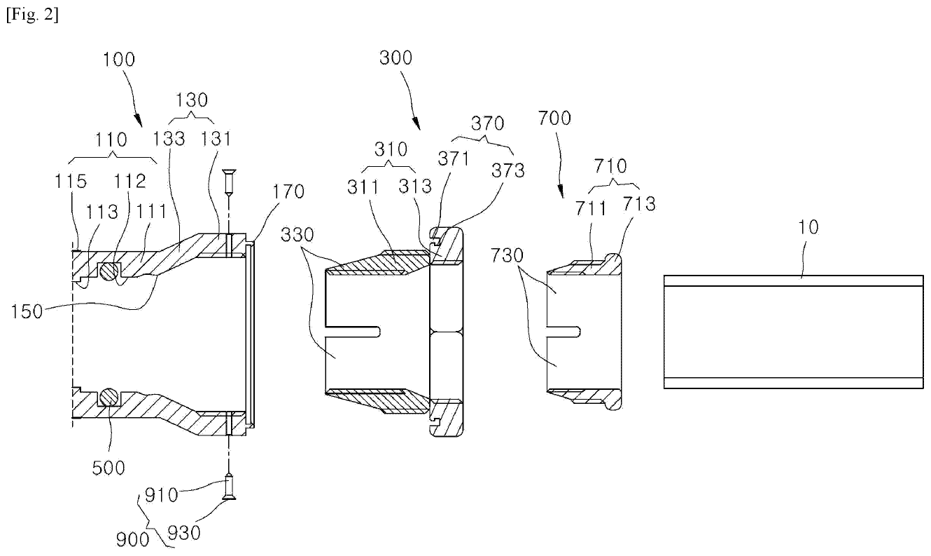

FIG. 1 is a cross-sectional view illustrating a connection device according to one embodiment of the present disclosure, and FIG. 2 is a block diagram illustrating a configuration of the connection device according to one embodiment of the present disclosure.

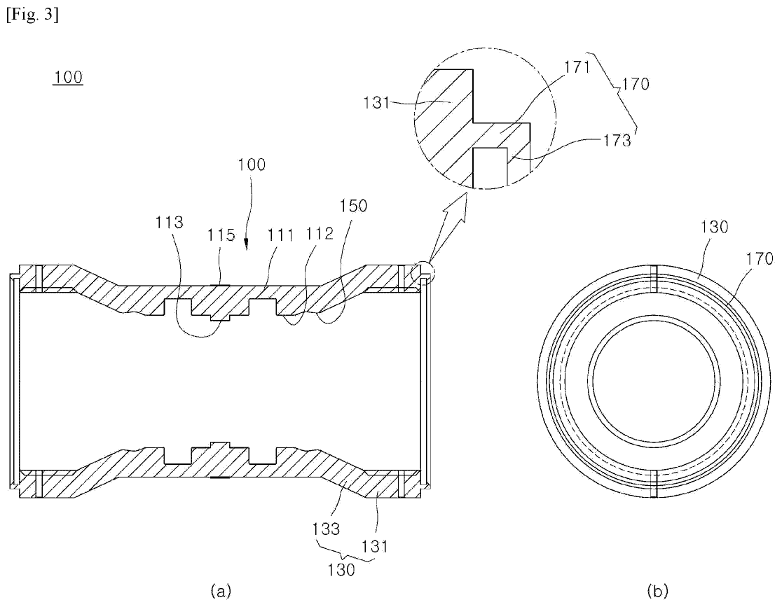

FIGS. 3A and 3B are respectively a cross-sectional view and a side view illustrating a housing part according to one embodiment of the present disclosure.

Referring to FIGS. 1 to 3B, the connection device 1 according to one embodiment of the present disclosure includes a housing part 100, a fixing part 300, and a sealing part 500.

One or more pipes 10 are inserted into the housing part 100. Here, the pipe 10 inserted into the housing part 100 includes a pipe for guiding movement of a fluid, and may be made of a material such as metal or synthetic resin. The housing part 100 according to the present embodiment includes a housing body portion 110 and a housing guide portion 130.

A pipe 10 is inserted into the housing body portion 110. In the present embodiment, the housing body portion 110 is exemplified as being formed in a substantially cylindrical shape, and the pipe 10 is inserted therein.

Besides, the housing body portion 110 may be manufactured in a shape in which a plurality of cylinders having different diameters are connected depending on the shape and number of the pipes 10 to be inserted, or may be formed in a ‘T’ shape or the like. In the present embodiment, the housing body portion 110 includes a housing body member 111 and a pipe insertion restriction portion 113.

The housing body member 111 has a housing body hole portion 112 through which the pipe 10 is inserted, and the pipe 10 is inserted into the housing body hole portion 112. In the present embodiment, the housing body member 111 is made of a metal material and may be connected to a neighboring housing body member 111 by welding, screw coupling, or the like.

The pipe insertion restriction portion 113 is formed to protrude from the housing body hole portion 112 to limit the insertion degree of the pipe 10. In the present embodiment, the pipe insertion restriction portion 113 is formed in a substantially ring shape along an inner peripheral surface of the housing body hole portion 112, and is provided in contact with a leading end of the pipe 10 depending on the degree of insertion of the pipe 10 to limit the extent to which the pipe 10 is inserted into the housing body member 111.

In the present embodiment, the housing body portion 110 further includes a pipe insertion indicating portion 115. The pipe insertion indication portion 115 is indicated on an outer peripheral surface of the housing body member 111 at a position corresponding to the pipe insertion restriction portion 113 so that the position of the leading end of the pipe 10 inserted in the housing body member 111 can be checked from the outside of the housing body member 111.

In the present embodiment, when the housing body member 111 is coupled by welding or the like at a position where the pipe insertion restriction portion 115 is applied, the pipe insertion indication portion 115 may have a groove formed to have the same width as that of the pipe insertion restriction portion 115 with reference to a portion where the housing body members 111 are coupled to each other, for example, a welding line.

In addition, the pipe insertion indication portion 115 may be indicated by coloring the outer peripheral surface of the housing body member 111 with paint or the like.

When the pipe insertion indication portion 115 is applied, an operator may accurately check the degree of insertion of the pipe 10. Accordingly, in the inserting operation of the pipe 10 or the like, before the pipe 10 is inserted into the housing body member 111, the pipe 10 can be accurately inserted or mounted by indicating a distance from the pipe insertion indication portion 115 to an end of the housing body member 111 on the pipe 10.

Accordingly, by allowing the operator to easily check the position of the pipe 10, the pipe insertion indication portion 115 can facilitate the operation for confirming the degree of insertion of the pipe 10 at the time of operation of management, disassembly, etc. of the connection device 1, and enable the accurate insertion of the pipe 10 to prevent damage to the pipe 10 and the like.

In addition, the connection device 1 in the present embodiment can insert the pipe 10 to an accurate position, thereby minimizing the front and rear clearance of the pipe 10 to ensure sealing between the housing body member 111 and the pipe 10. Further, the connection device 1 in the present embodiment can secure uniform assembly regardless of the skill level of the operator by applying the pipe insertion indication portion 115.

The housing guide portion 130 is connected to the housing body portion 110 and is formed so that an inner diameter thereof is gradually decreased as going toward the housing body portion 110. Accordingly, in the present embodiment, the housing guide portion 130 allows the fixing part 300 to press the pipe 10 by allowing a front end portion of the fixing part 300 to contract while moving along an inner surface of the housing guide portion 130.

An inclination angle of the inner inclined surface of the housing guide portion 130 may be equal to or greater than an inclination angle of the front end portion of the fixing part 300 to increase the deformation of the front end portion of the fixing part 300.

Accordingly, in the present embodiment, when the front end portion of the fixing part 300 moves along the inner inclined surface of the housing guide portion 130, the front end portion of the fixing part 300 contracts to compress and fix the pipe 10. In the present embodiment, the housing guide portion 130 includes a pipe insertion portion 131 and a pipe guide portion 133.

An opening is formed in the pipe insertion part 131 and the pipe 10 is inserted into the pipe insertion portion 131 through the opening. In the present embodiment, the pipe insertion part 131 is formed in a substantially cylindrical shape so that the pipe 10 may be inserted therein, and a side of the pipe insertion portion 131 opposite to the opening is connected to the pipe guide portion 133.

In the present embodiment, the pipe insertion part 131 has a screw thread formed on an inner peripheral surface thereof and is screw-coupled with the fixing part 300, so that when the fixing part 300 rotates with respect to the housing part 100, the fixing part 300 can move in a longitudinal direction of the housing part 100.

The pipe guide portion 133 connects the pipe insertion part 131 and the housing body portion 110, and is formed to have an inner diameter gradually decreased toward the housing body portion 110. In the present embodiment, one end of the pipe guide portion 133 is connected to the pipe insertion part 131, and the other end having an inner diameter smaller than that of the one end of the pipe guide portion 133 is connected to the housing body portion 110.

Since the inner diameter of the pipe guide portion 133 is formed to be gradually decreased along the insertion direction of the pipe 10, the front end portion of the fixing part 300 moving along the inner surface of the pipe guide portion 133 can be contracted.

In the present embodiment, the housing part 100 further includes a pressing protrusion 150. The pressure protrusion 150 protrudes from an inner peripheral surface of the housing body portion 110 or the pipe guide portion 133 and presses the pipe 10 or the fixing part 300 moving toward the housing body hole portion 112.

In the present embodiment, the housing body portion 110 and the housing guide portion 130 may include a metal material and may be integrally formed.

In the present embodiment, the housing part 100 may further include a fixing locking portion 170. The fixing locking portion 170 is formed in the housing guide portion 130, specifically, the pipe insertion part 131, and is configured to lock the fixing part 300 depending on the degree of insertion of the fixing part 300 into the housing body portion 110 or the housing guide portion 130.

In the present embodiment, the fixing locking portion 170 includes a fixing locking body 171 protruding from the housing guide portion 130 in the insertion direction of the pipe 10, and a fixing locking member 173 protruding from the fixing locking body 171 in a direction intersecting with the protruding direction of the fixing locking body 171.

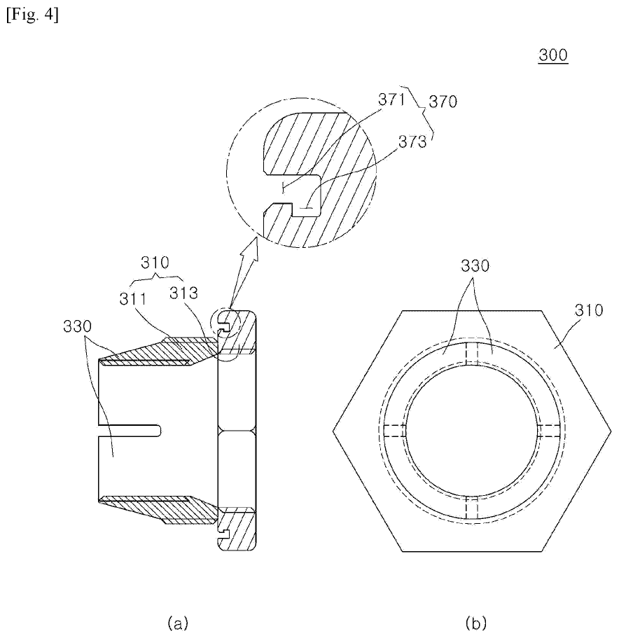

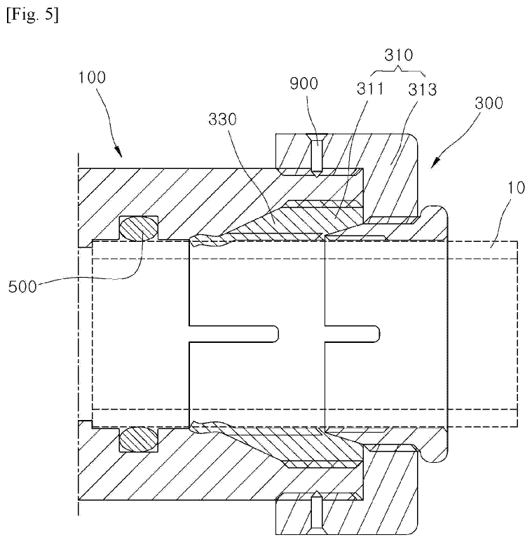

FIGS. 4A and 4B are respectively a cross-sectional view and a side view illustrating the fixing part according to one embodiment of the present disclosure, and FIG. 5 is a cross-sectional view illustrating a fixing part according to another embodiment of the present disclosure.

Referring to FIGS. 4A, 4B and 5, the fixing part 300 is inserted between the pipe 10 and the housing part 100 in response to rotation and fixes the pipe 10 to the housing part 100. In the present embodiment, the fixing part 300 includes a rotation member 310 and a fixing member 330.

The rotation member 310 is screw-coupled with the housing part 100 and moves in the longitudinal direction of the housing part 100 in response to rotation. In the present embodiment, the rotation member 310 includes a rotation coupling part 311 and a rotation body part 313.

A screw thread is formed on the rotation coupling part 311 to be screw-coupled with the housing part 100. The degree to which the rotation coupling part 311 is inserted in the housing part 100 is adjusted depending on the degree to which the rotation coupling part 311 is screw-coupled with the housing part 100.

Referring to FIGS. 4A and 4B, a screw thread is formed on an outer peripheral surface of the rotation coupling part 311 and may be screw-coupled with the outer peripheral surface of the housing part 100. In addition, as shown in FIG. 5, the rotation coupling part 311 may be provided to surround both the inner and outer sides of the opening portion of the housing part 100 and may be screw-coupled with the outer peripheral surface of the housing part 100.

The rotation body part 313 may be connected to the rotation coupling part 311 and may have an outer diameter larger than an inner diameter of the opening of the housing part 100 to limit the insertion degree of the rotation coupling part 311.

In addition, the rotating body part 313 has an outer peripheral surface formed in a substantially polygonal shape to facilitate work by preventing a tool from slipping and improving the transmission of force when being rotated with the tool or the like.

In the present embodiment, the fixing part 300 further includes a housing locking portion 370 to prevent the rotating member 310 or the fixing member 330 from being separated from the housing part 100.

In the present embodiment, the housing locking portion 370 is provided in a shape corresponding to the fixing locking portion 170 at a position corresponding to the fixing locking portion 170, and when the rotating member 310 is inserted into the housing part 100 by a preset distance or more, the housing locking portion 370 is engaged with the fixing locking portion 170. In the present embodiment, the housing locking portion 370 includes a housing locking insertion portion 371 and a housing locking member 373.

The housing locking insertion portion 371 is concavely formed in the rotation member 310, and when the rotation member 310 moves by a preset distance or more in the insertion direction of the pipe 10, the fixing locking portion 170 is inserted into the housing locking insertion portion 371.

Since the housing locking member 373 is concavely formed in a shape corresponding to the fixing locking member 173 to lock it at a position corresponding to the fixing locking member 173, the fixing locking member 173 is fitted in the housing locking member 373 to prevent the fixing part 300 including the rotation member 310 from moving in the housing part 100.

In the present embodiment, it has been described that the fixing locking portion 170 is formed to protrude, and the housing locking portion 370 is concavely formed to correspond to the shape of the fixing locking portion 170, but it goes without saying that the shapes of the fixing locking portion 170 and the housing locking portion 370 may be changed within the technical idea of the present disclosure that the fixing locking portion 170 and the housing locking portion 370 are engaged with each other to prevent relative movement thereof.

That is, the housing locking portion 370 may protrude from the rotating member 310, and the fixing locking portion 170 may be concavely formed in the housing guide portion 130 so that they are engaged with each other.

In the present embodiment, the fixing member 330 is connected to the rotation member 310, and is provided in a shape in which an outer diameter thereof gradually decreases as it goes in the insertion direction of the pipe 10, and is interposed between the housing unit 100 and the pipe 10. In the present embodiment, the fixing member 330 is deformed while moving in contact with the housing guide portion 130 in response to the rotation of the rotation member 310 to press the pipe 10.

In the present embodiment, a plurality of fixing members 330 are provided and arranged to be spaced apart from each other at equal intervals in a circumferential direction of the rotating member 310.

Since the plurality of fixing members 330 are arranged to be spaced apart, when the front end portions of the fixing members 330 receives a force while moving in contact with the housing guide 130, a gap between the fixing members 330 is reduced, which prevents the fixing members 330 from being twisted by the deformation of the fixing members 330 and enables the fixing members 330 to press the pipe 10.

In the present embodiment, the rotating member 310 and the fixing member 330 includes a metal material and are integrally formed.

The sealing part 500 is provided between the housing part 100 and the pipe 10, and is deformed when the pipe 10 is inserted into the housing part 100 to seal between the pipe and the housing part 100. In the present embodiment, the sealing part 500 includes an elastic material such as synthetic resin or the like, and when the pipe 10 is inserted into the housing part 100, the sealing part 500 is deformed to seal a gap between the pipe 10 and the housing part 100.

In particular, in the present embodiment, the sealing part 500 includes various materials such as NBR, EPDM or the like, so that sealing performance may be maintained even in case of dents during assembly, or a medium/high pressure.

In the present embodiment, the sealing part 500 is formed in a substantially ‘ring’ shape and is mounted on the housing part 100 in a manner that is inserted into a groove concavely formed on the inner peripheral surface of the housing part 100.

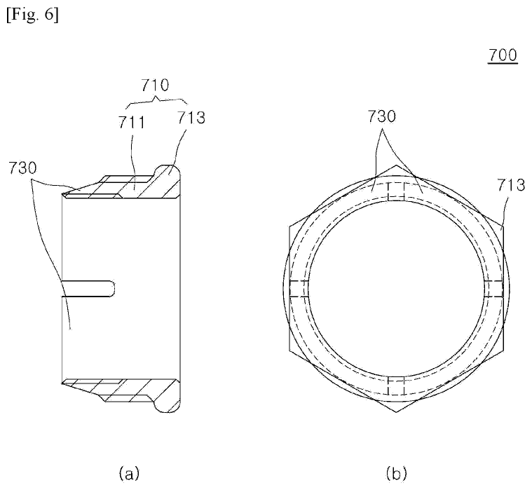

FIGS. 6A and 6B are respectively a cross-sectional view and a side view illustrating a fixing reinforcement part according to one embodiment of the present disclosure. Referring to FIGS. 1, 2, 6A and 6B, in the present embodiment, the connection device 1 may further include a fixing reinforcement part 700. The fixing reinforcement part 700 is inserted between the fixing part 300 and the pipe 10 to press the fixing part 300.

Accordingly, the fixing reinforcement part 700 prevents the fixing part 300 from being released from the state in which the fixing part 300 is coupled to the housing part 100 or the pipe 10, and prevents the pipe 10 from sagging when the pipe 10 is connected. In the present embodiment, the fixing reinforcement part 700 includes a reinforcing rotation member 710 and a reinforcing fixing member 730.

The reinforcing rotation member 710 is screw-coupled with the fixing part 300, and is moved along the longitudinal direction of the housing part 100 in response to rotation and screw-coupled with the fixing part 300. In the present embodiment, the reinforcing rotation member 710 includes a reinforcing rotation coupling portion 711 and a reinforcing rotation body portion 713.

The reinforcing rotation coupling portion 711 has a screw thread formed on an outer peripheral surface thereof and is screw-coupled to the fixing part 300. The degree to which the reinforcing rotation coupling part 711 is inserted in the fixing part 300 is adjusted depending on the degree to which the reinforcing rotation coupling part 711 is screw-coupled with the fixing part 300.

The reinforcing rotation body portion 713 is connected to the reinforcing rotation coupling part 711 and has an outer diameter larger than an inner diameter of a hole formed in the fixing part 300 to limit the insertion degree into the fixing part 300.

In addition, the reinforcing rotation body portion 713 has an outer peripheral surface formed in a substantially polygonal shape to facilitate work by preventing a tool from slipping and improving the transmission of force when being rotated with the tool or the like.

The reinforcing fixing member 730 is connected to the reinforcing rotation member 710, and is provided in a shape in which an external diameter thereof gradually decreases as it goes in the insertion direction of the pipe 10, and is interposed between the fixing part 300 and the pipe 10.

In the present embodiment, the reinforcing fixing member 730 is deformed while being moved in contact with the inner inclined surface of the fixing part 300 in response to the rotation of the reinforcing rotating member 710 to press the pipe 10.

In the present embodiment, a plurality of reinforcing fixing members 730 are provided and are arranged to be spaced apart from each other at equal intervals in a circumferential direction of the reinforcing rotating member 710.

Since a plurality of reinforcing fixing members 730 are arranged to be spaced apart, when front end portions of the reinforcing fixing members 730 receive a force while moving in contact with the inner inclined surface of the fixing part 300, a gap between the reinforcing fixing members 730 is reduced, which enables the reinforcing fixing member 730 to press the pipe. In the present embodiment, the reinforcing rotation member 710 and the reinforcing fixing member 730 includes a metal material and are integrally formed.

In the present embodiment, the connection device 1 may further include a loosening prevention part 900. The loosening prevention part 900 prevents the fixing part 300 from rotating with respect to the housing part 100 in a manner that passes through the housing part 100 to press the fixing part 300 (see FIGS. 1 and 2), or conversely, passes through the fixing part 300 to press the housing part 100 (See FIG. 5).

Alternatively, the loosening prevention part 900 prevents the fixing part 300 from rotating with respect to the housing part 100 in a manner that passes through the fixing part 300 to press the housing part 100 (See FIG. 5), or the like.

In the present embodiment, the loosening prevention part 900 includes a loosening prevention penetration portion 910 and a loosening prevention penetration adjustment portion 930.

The loosening prevention penetration part 910 passes through the fixing part 300 or the housing part 100 and has a screw thread formed on an outer peripheral surface thereof.

The loosening prevention penetration adjustment portion 930 is connected to the loosening prevention penetration portion 910 and has a larger diameter than that of the loosening prevention penetration portion 910 to adjust the degree to which the loosening prevention penetration portion 910 is coupled.

One or more loosening prevention parts 900 are provided on a circumference with respect to the rotation axis of the housing part 100 or the fixing part 300. When a plurality of loosening prevention parts 900 are provided, they are arranged at equal intervals to stably fix the fixing part 300 to the housing part 100. In the present embodiment, the loosening prevention part 900 may be exemplified as a tapping bolt with a flat head.

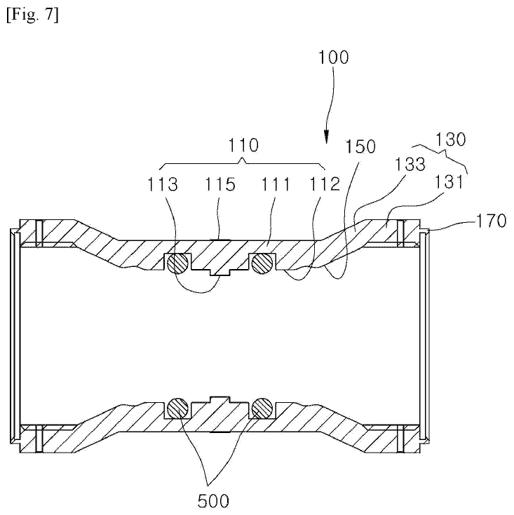

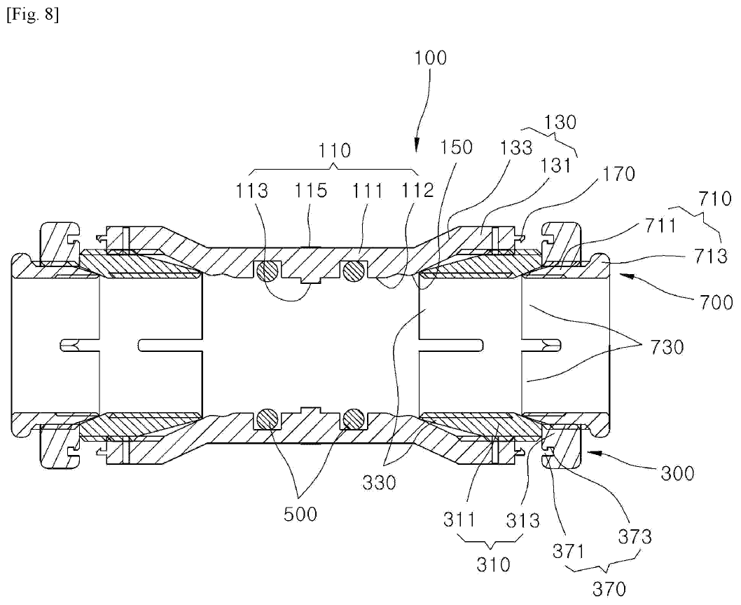

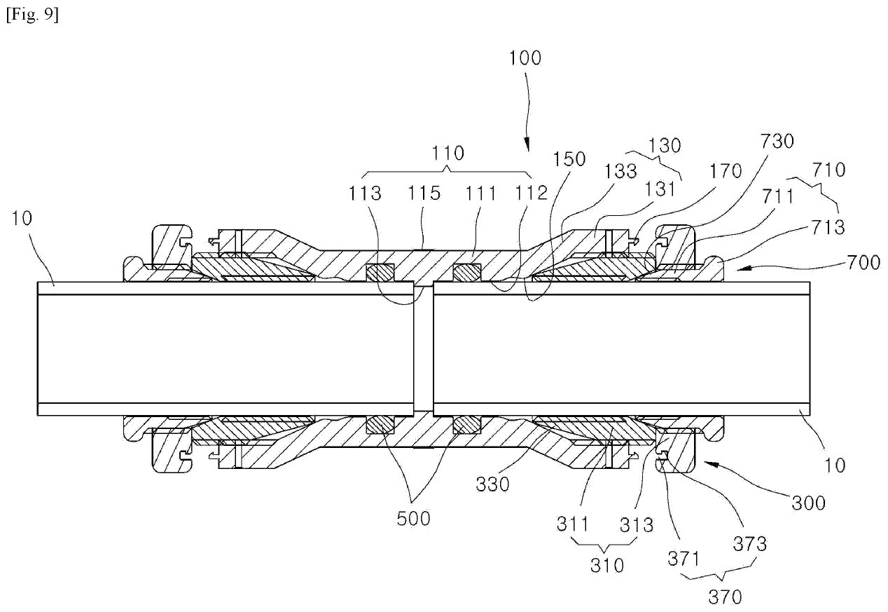

FIG. 7 is a cross-sectional view illustrating a state in which the housing part and the sealing part are coupled to each other according to one embodiment of the present disclosure, FIG. 8 is a cross-sectional view illustrating a state in which the fixing part and the fixing reinforcement part are coupled to the housing part according to one embodiment of the present disclosure, and FIG. 9 is a cross-sectional view illustrating a state in which a pipe is inserted into the housing part in the connection device according to one embodiment of the present disclosure.

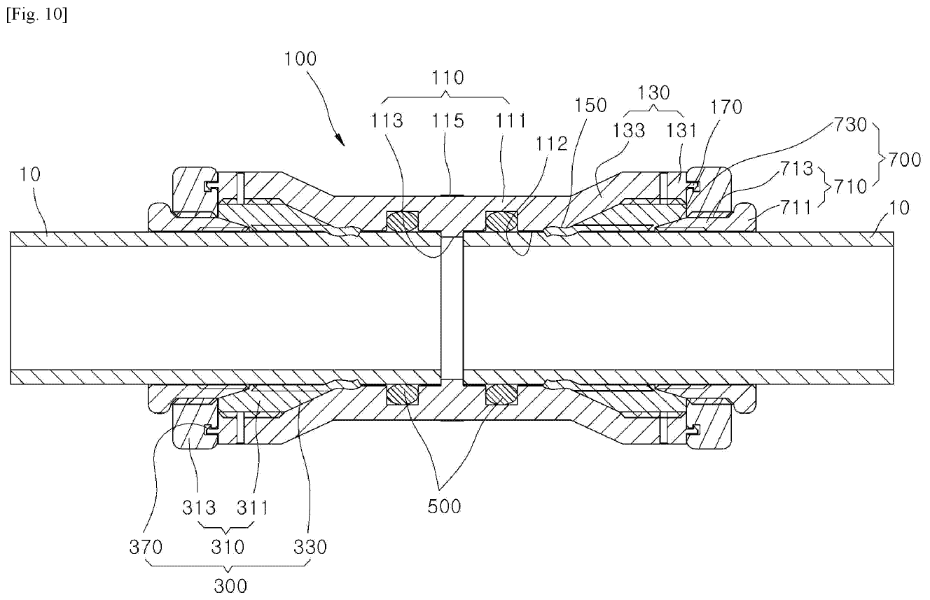

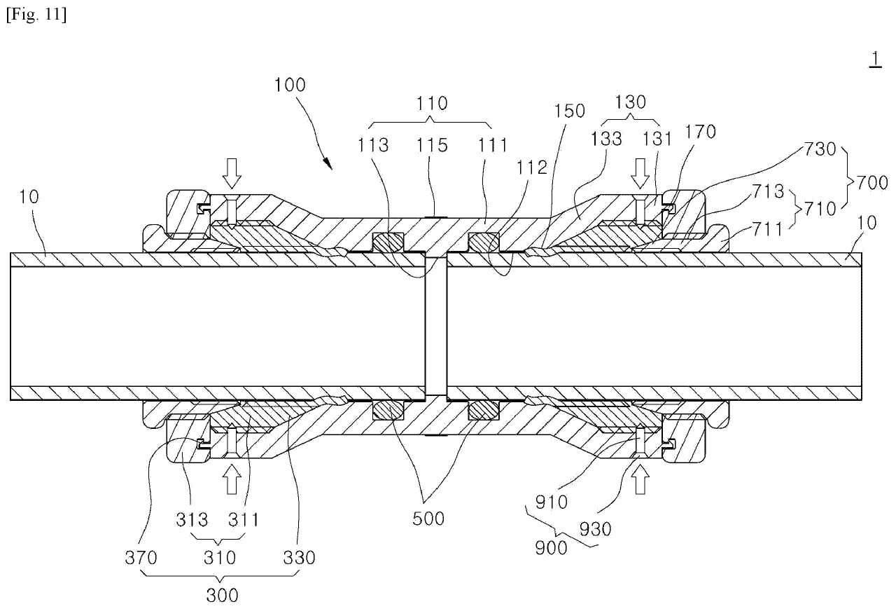

FIG. 10 is a cross-sectional view illustrating that the fixing part and the fixing reinforcement part are rotated to fix the pipe in the connection device according to one embodiment of the present disclosure, and FIG. 11 is a cross-sectional view illustrating that the loosening prevention part is coupled to the housing part and the fixing part in the connection device according to one embodiment of the present disclosure.

Hereinafter, the operating principle and effect of the connection device 1 according to one embodiment of the present disclosure will be described with reference to FIGS. 7 to 11.

First, the sealing part 500 is pushed into the inside of the housing part 100 so that the sealing part 500 is fitted into the groove formed on the inner surface the housing part 100. Grease, and the like may be applied to the sealing part 500 so that airtightness between the pipe 10 and the housing part 100 can be maintained (see FIG. 7).

When the sealing part 500 is mounted on the housing part 100, the fixing part 300 and the housing part 100 are assembled with rotation. In this case, the assembling is temporarily performed through an manual operation by an operator, so that the pipe 10 may be inserted into the housing 100 through the fixing reinforcement part 700 and the fixing part 300 (see FIG. 8).

When the fixing part 300 and the fixing reinforcement part 700 are temporarily assembled to the housing part 100, the pipe 10 is inserted through the fixing reinforcement part 700 and the fixing part 300 through the hollow hole formed therein, and the leading end of the pipe 10 is brought into contact with the pipe insertion restriction portion 113. The leading end of the pipe 10 may be chamfered before assembling so that the pipe 10 can stably reach a preset position (see FIG. 9).

In addition, the operator can indirectly check whether the pipe 10 has reached the preset position by inserting the pipe 10 with reference to the pipe insertion indication portion 115 indicated on the outer surface of the housing 100.

When the pipe 10 is inserted into the housing part 100, the operator rotates the fixing part 300 with a tool such as a spanner so that the fixing part 300 moves in the longitudinal direction of the housing part 100 while being screw-coupled with the housing part 100, and the fixing member 330 compresses and fixes the pipe 10. In addition, due to the screw thread formed on the inner peripheral surface of the fixing part 300, a screw thread is formed on the outer peripheral surface of the pipe 10, so that the fixing part 300 and the pipe 10 are also strongly fixed by screw coupling.

When the screw coupling between the fixing part 300 and the housing part 100 is completed, by rotating the fixing reinforcement part 700 with respect to the fixing part 300 to strengthen the screw coupling with the fixing part 300, the coupling between the fixing part 300 and the housing part 100 is strengthened (see FIG. 10).

In addition, by additionally fixing the housing part 100 and the fixing part 300 using the loosening prevention part 900, the coupling between the fixing part 300 and the housing part 100 is prevented from being loosened (refer to FIG. 11).

Accordingly, the connecting device 1 according to the present embodiment can easily connect various pipes 10 with a simple configuration. Further, the connection device 1 according to the present embodiment can accurately control and indicate the insertion degree of the pipe 10 inserted into the housing 100 by applying the pipe insertion restriction portion 113 and the pipe insertion indication portion 115 to the housing part 100.

In addition, the connection device 1 according to the present embodiment can stably fix the pipe 10 and prevent the pipe 10 from sagging by applying the fixing part 300 and the fixing reinforcement part 700.

Further, the connection device 1 according to the present embodiment can prevent the fluid guided along the pipe from leaking between the housing part 100 and the pipe 10 by applying the sealing part 500 between the housing part 100 and the pipe 10.

Furthermore, the connection device 1 according to the present embodiment prevents loosening of the fixing part 300 by applying the fixing part 170, the housing locking portion 370, the fixing reinforcement part 700, and the loosening prevention part 900, so that the connection state of the pipe 10 can be stably maintained.

Although the present disclosure has been described with reference to the embodiments shown in the drawings, this is merely an example, and it will be understood by those skilled in the art that various modifications and equivalent other embodiments are possible.

Accordingly, the technical protection scope of the present disclosure should be determined by the following claims.

1. A connection device comprising:
a housing part into which a pipe is inserted;
a fixing part which is inserted between the pipe and the housing part in response to rotation to fix the pipe; and
a sealing part provided between the housing part and the pipe to seal between the housing part and the pipe.

2. The connection device of claim 1, wherein the housing part includes:
a housing body portion into which the pipe is inserted; and
a housing guide portion which is connected to the housing body portion and has an inner diameter gradually decreased as going toward the housing body portion.

3. The connection device of claim 2, wherein the housing body portion includes:
a housing body member in which a housing body hole portion into which the pipe is inserted is formed; and
a pipe insertion limiting portion protruding from the housing body hole portion to limit the degree of insertion of the pipe.

4. The connection device of claim 2, wherein the housing guide portion includes:
a pipe insertion portion into which the pipe is inserted; and
a pipe guide portion which connects the pipe insertion portion and the housing body portion, and is formed to have an inner diameter gradually decreased as going toward the housing body portion.

5. The connection device of claim 4, wherein the housing part further includes a pressing protrusion protruding from an inner peripheral surface of the housing body portion or the pipe guide portion to press the pipe or the fixing part moving toward the housing body hole portion.

6. The connection device of claim 2, wherein the fixing part includes:
a rotating member rotatably coupled to the housing part and moved in a length direction of the housing part in response to rotation; and
a fixing member connected to the rotating member, and provided in a shape in which an outer diameter is gradually decreased in an insertion direction of the pipe.

7. The connection device of claim 6, wherein the rotating member is screw-coupled with the housing part.

8. The connection device of claim 6, wherein the fixing member is deformed as being moved in contact with the housing guide portion in response to rotation of the rotation member to press the pipe.

9. The connection device of claim 8, wherein the fixing member includes a plurality of fixing members arranged in a circumferential direction of the rotating member.

10. The connection device of claim 6, wherein the rotating member and the fixing member are integrally formed.
